(19) United States
(12) Patent Application Publication
(10) Pub. No.: US 2011/0284787 A1
(43) Pub. Date: Nov. 24, 2011

(54) PRE-CLOSING APPARATUS OF A MACHINE

(76) Inventor: Marinus Cornelis Adrianus Heij, As Hooge Mierde (NL)

(21) Appl. No.: 13/129,659

(22) PCT Filed: Nov. 15, 2009
(86) PCT No.: PCT/EP2009/065182

§ 371 Date: Aug. 9, 2011

(30) Foreign Application Priority Data
Nov. 17, 2008 (DE) 10 2008 057 683.2

(51) Int. Cl. F16K 1/22

(52) U.S. Cl. 251/305

(57) ABSTRACT

A pipe-closing apparatus of a machine which is suitable for processing foodstuff mixtures, contains a throttling valve arranged in a pipeline and has a closing element configured with respect to the pipeline with two sealing sections. The apparatus further has an activation apparatus for transferring the closing element into an open or closed position and vice versa. Accordingly, the closing element is formed by a three-dimensional rotationally symmetrical body which has a passage, wherein, in the open position of the closing element, at least the inlet and outlet openings of the passage are aligned with the pipeline, and, in the closed position, the passage is subjected to a pressure for the ingress of compressed air. The pipe-closing apparatus is suitable equally for use in a machine for producing a milk-containing ice cream and for processing and/or preparing, for example, caramels, jams, sweets, crème bavaroise, milk creams and confectioner's creams.

The present invention relates to a pipe-closing apparatus of a machine which is suitable for processing, inter alia, food mixtures, in particular of a machine for producing a milk-based ice cream, wherein raw milk and/or other unpasteurized products can wholly or partially be used as the base product, comprising a butterfly valve arranged in a pipeline and having a closing element which is designed with two sealing portions with respect to the pipeline, and an activation apparatus for transferring the closing element into an open or closed position and vice versa.

Machines for processing food mixtures, which machines also comprise, for example, pasteurizers and homogenizers, can be equipped with a series of pipelines and/or tanks in which various processing phases are carried out. The tanks are connected to one another by means of pipes, which are designed with closing apparatuses comprising, for example, a butterfly valve which regulates the intermittent flow of the food mixture.

Documents FR 2 341 083, GB 435 059 and FR 726 548 disclose, by way of example, pipe-closing apparatuses comprising a butterfly valve which is designed with a removable, inflatable sealing ring over the periphery.

The known butterfly valves, however, due to machining tolerances or as the result of wear and tear over a period of time, can exhibit a slight suction action or comparable leakages.

In a specific case of a machine for producing homemade ice cream, to give an illuminating yet non-restricting example, the processed food mixture is generally based on raw milk and/or other unpasteurized products. Machines of the known type comprise the use of heated pasteurizers, optionally with alternating pipelines, and cooled thickeners, in particular so-called freezing cylinders, which are designed with mixers. The ice cream (as the end product) is then supplied through an opening present on the foremost part of the thickener or freezing cylinder.

The connection of an upper pasteurizing tank of non-pasteurized raw milk, and/or of food mixtures which are possibly based on other unpasteurized food products, to a lower thickening tank or freezing cylinder by means of a pipe closed off by a butterfly valve is already known. At the end of the pasteurizing phase of the food mixture, an operator, for instance, manually activates the butterfly valve in order to discharge the pasteurized mixture from the upper tank into the lower tank.

The pasteurizing treatment of a first food mixture can be realized simultaneously with the thickening treatment of a previously pasteurized compound, so that the machine can be operated continuously. Furthermore, if the times required for the pasteurization and thickening method are virtually identical, then the simultaneous processing enables the production process to be optimized.

If the product which is to be pasteurized is non-pasteurized milk or a food mixture containing raw milk, then possible suction of the butterfly valve, even if minimal, cannot be tolerated. In some European states there are already, beyond general consumer protection regulations, specific provisions relating to the treatment of milk and/or of milk-based food mixtures. The mixing of non-pasteurized milk with food mixtures which do not have to be subjected to any subsequent pasteurization treatment is hence totally prohibited.

In these machines, the problem therefore exists that they must have a closing apparatus for the product in the pasteurization phase, which closing apparatus has perfect sealing even over a period of time. The same problem can also exist generally, however, for machines which are suitable for processing or preparing food mixtures, such as, for example, caramel, jam, candies, crème bavaroise, milk cream or so-called confectioner's creams etc. Furthermore, this apparatus must be produced from a material which is suitable for use for food and it must be suitably shaped to allow cleaning operations.

EP 0 350 017 A1 discloses, in particular for applications in which provision must be made for a separation of product liquid and cleaning liquid, a shut-off member with leakage indicator, which shut-off member is insertable between two lines and is a ball cock having a spherical closing body which, in the direction of flow of a medium, is sealed on both sides by ring seals inserted in a positionally fixed manner in the connecting sockets of the ball cock housing and framed by connecting flanges attachable to the housing, from the dead space of which ball cock, said dead space being formed between the housing, the seals and the closing body, extends a leakage line leading into the open air.

EP 1 319 876 B1 discloses a pipe-closing apparatus of a machine which is suitable for processing food mixtures, comprising a butterfly valve, which is designed with a peripheral sealing portion on a pipe, and activation apparatuses for transferring the valve into an open or closed position and vice versa, wherein the peripheral sealing portion is pressurized by a pneumatic circuit for the intake of compressed air; wherein the valve is designed on the outside with a peripheral groove between two sealing lips, and wherein the valve is made up of a disk body, produced from an elastically resilient thermoplastic material, and at least one reinforcing core having a plate.

A valve which, in particular, contains rubber and/or is produced from an elastically resilient thermoplastic material has the drawback, however, that, already due to the constant change of at least top-side heating and subsequent contact with the cold mixture which is newly to be pasteurized, a relatively rapid wearing or embrittlement of the valve and, in consequence thereof, leakage, in particular of the peripheral sealing portions, can materialize. The danger of leaks is also promoted by the fact that a valve configured as a disk body remains constantly in the flow channel and is circumflowed by pasteurized medium at a temperature of at least 72° to 85°, so that the valve requires regular cleaning and disinfection with cleaning agents at a temperature of up to 95°. The risk of leakage which exists because of such thermals is attempted to be countered by relatively frequent complete replacement of the valve, which already for this reason, but also due to the associated machine downtimes, leads to increased maintenance costs. Otherwise, even with leakages lasting just 1 to 3 sec., contamination of the food products would have to be assumed and any sale of these same prohibited by law.

The present invention seeks to avoid this. The object of the invention is to provide a pipe-closing apparatus, which is improved in relation to the prior art, for a machine for processing food mixtures, in particular of a machine for producing a milk-based ice cream.

This object is achieved by a pipe-closing apparatus according to the features of independent patent claim 1. Advantageous configurations and refinements, which can be used singly or in combination with one another, are the subject of the dependent claims.

The pipe-closing apparatus according to the invention, in particular of an ice cream machine or other machines, of the type stated in the introduction, for processing food mixtures is distinguished by a closing element which is formed by a three-dimensional, rotationally symmetrical body having a passage, wherein, in the open position of the closing element, at least the inlet and outlet opening of the passage are aligned with the pipeline, and wherein, in the closed position of the closing element, the passage can be pressurized or subjected to a pressure by a pneumatic circuit for the intake of compressed air.

The use of a butterfly valve having a three-dimensional, rotationally symmetrical body as the closing element here has a significantly improved sealing effect compared to the lips of a disk body which are known from the prior art, namely a sealing portion which is effective not only peripherally but also over a wide area and, in consequence thereof, enjoys a lesser susceptibility to leaks, in particular due to temperature change.

The three-dimensional, rotationally symmetrical body forming the closing element can be realized as a hollow body, the cavity of which advantageously at the same time forms the passage.

Alternatively hereto, the three-dimensional, rotationally symmetrical body forming the closing element can also be of solid construction, with a through bore forming the passage.

According to the invention, the diameter. at least of the inlet and outlet opening of the passage is preferably substantially equal to the inner diameter of the pipeline, advantageously no bodies whatsoever and scarcely any body contours remaining in the flow channel, so that thicker or semi-liquid food mixtures such as, in particular, confectioner's creams or comparable substances which usually already thicken with the heating (pasteurization) are also able to flow through the valve with as little hindrance as any cleaning agents, whereby the risks of wear and damage, and thus leakages of the valve, are minimized. For, unlike in the prior art, where the closing element of the butterfly valve, a disk body resident in the flow channel, has to be completely removed and cleaned after each wearing process, if it is wished to avoid remnants of food mixtures from becoming dried on, in the open position of the passage of a closing element formed by a three-dimensional, rotationally symmetrical body with inlet and outlet opening corresponding to the pipeline, said closing element is fully flowed through and, when cleaning agents are used, is cleaned or disinfected, so that, even when the machine is first started up, a plain and simple pre-cleaning process will usually suffice and major disassemblies are avoided.

As the activation device, a pivot which makes contact along the rotational axis of the closing element can preferably be provided.

For the sake of simplicity, the activation can be configured, for instance, such that that end of the pivot which is facing toward the closing element engages in a receptacle configured in the rotationally symmetrical body.

At the opposite end of the pivot facing away from the closing element, a manual operating element or an automated actuator for transferring the rotationally symmetrical body into the open or closed position and vice versa can selectively be provided. Insofar as an automated actuator is used, this can be configured such that it is hydraulically, pneumatically and/or electrically operable.

The three-dimensional, rotationally symmetrical body forming the closing element preferably has the shape of a spherical body. According to installation space and/or use, other three-dimensional, rotationally symmetrical objects such as double-cone bodies or ellipsoids can also, however, be used.

According to the invention, the two sealing portions of the closing element are preferably formed by shell surfaces of the spherically or rotationally symmetrical body, which preferably bear against sealing bodies of spherically or rotationally layered configuration.

The small diameter d2 of the sealing body bearing in spherically or rotationally layered configuration against the shell surface of the spherically or rotationally symmetrical body here preferably corresponds to the diameter of the inlet or outlet opening of the passage configured in the spherically or rotationally symmetrical body.

The large diameter dl of the sealing body bearing in spherically or rotationally layered configuration against the shell surface of the spherically or rotationally symmetrical body can, according to installation space and/or use, in a first embodiment of the layered sealing body, be arranged already just a few millimeters x, for example between 1.5 and 5 millimeters, distant from the small diameter d2, or, in a second embodiment of the layered sealing body, substantially correspond with the maximum spherical body diameter or the maximum rotational body diameter.

Particularly in the first embodiment of a sealing body, it has proved successful to feed the compressed air into the passage through an opening configured in the valve housing. The inherent risk of germ pool formation is herein advantageously avoided.

Insofar as, in particular, the second embodiment of a sealing body is used, it is preferred that the compressed air is guided into the passage through preferably mutually corresponding openings configured in the pivot and in the top side of the body. Due to the introduction of compressed air through the pivot, no change in or, in consequence thereof, even damage to the sealing bodies is produced, which likewise precludes the danger of potential germ pools.

Finally, in particular the three-dimensional, rotationally symmetrical body of the valve, which forms the closing element, expediently consists of a food-suitable material, in particular of metal such as special steel or aluminum, of polyethylene (PE)-containing plastics or of a ceramic. Advantageously, the sealing bodies are also designed to be suited to the working pressure and to the working temperature of the machine and are preferably produced from polyethylene (PE)-containing plastics or from a ceramic. The respectively accompanying relinquishment of a closing element containing, in particular, rubber-containing and/or elastically resilient thermoplastic material advantageously eliminates the known drawbacks associated therewith.

The inventive pipe-closing apparatus of a machine which is configured to be suitable for processing food mixtures is equally suitable for use in a machine for producing a milk-containing ice cream as for processing or preparing, for example, caramel, jam, candies, crème bavaroise, milk cream or so-called confectioner's creams.

Additional details and further advantages of the invention are described below by way of example with reference to an ice cream machine, to which the present invention is not however limited, and in conjunction with the appended drawing, in which, in schematic representation:

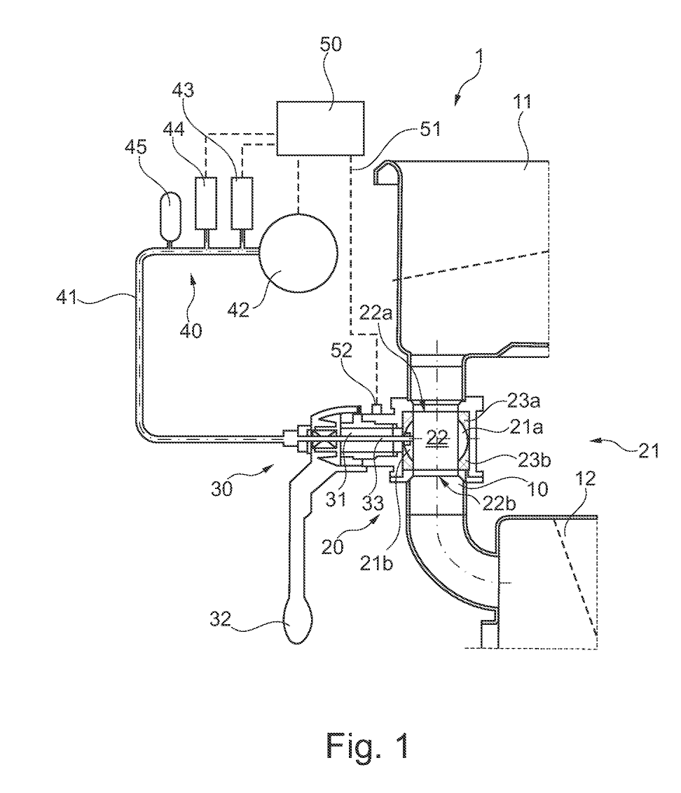

FIG. 1 shows in a side view an ice cream machine with a pipe-closing apparatus in an open position;

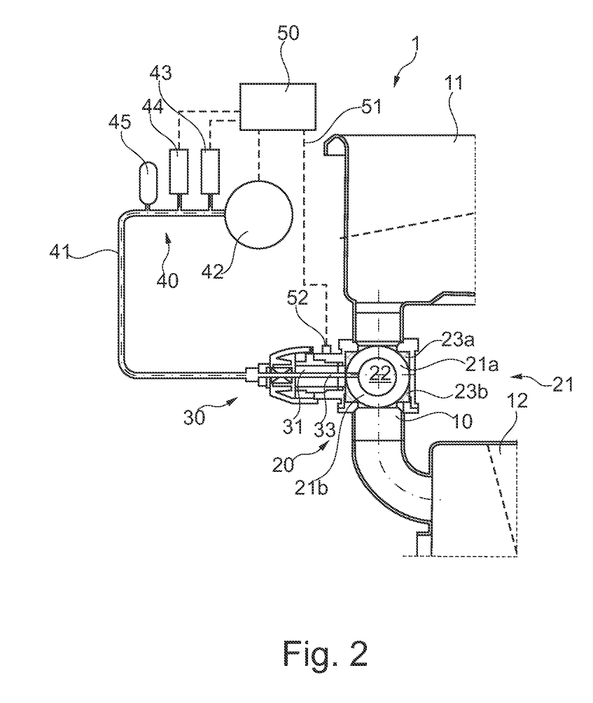

FIG. 2 shows the ice cream machine from FIG. 1 with a pipe-closing apparatus in a closed position;

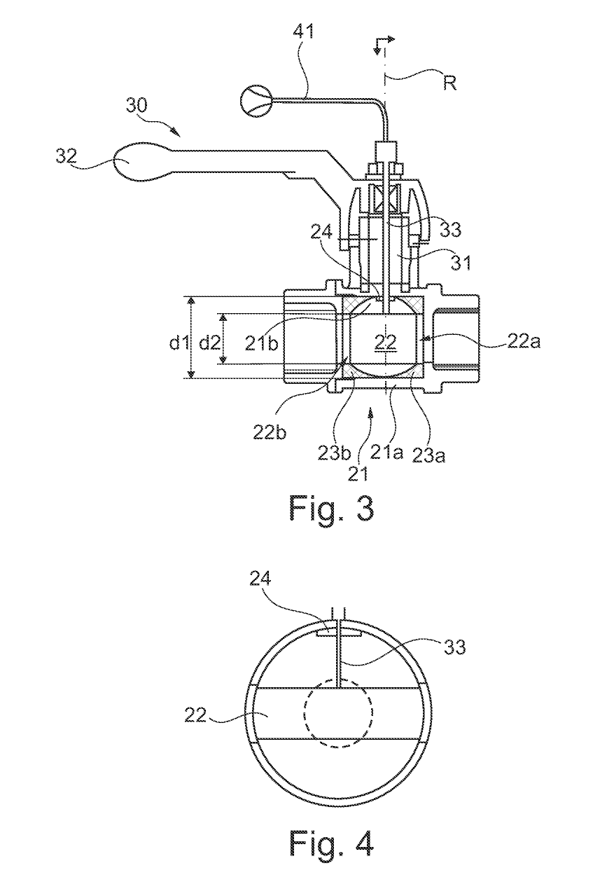

FIG. 3 shows the pipe-closing apparatus from FIGS. 1 and 2 in isolation, with compressed air fed into the passage via the pivot;

FIG. 4 shows an enlarged detail of the closing element of the pipe-closing apparatus according to FIG. 3;

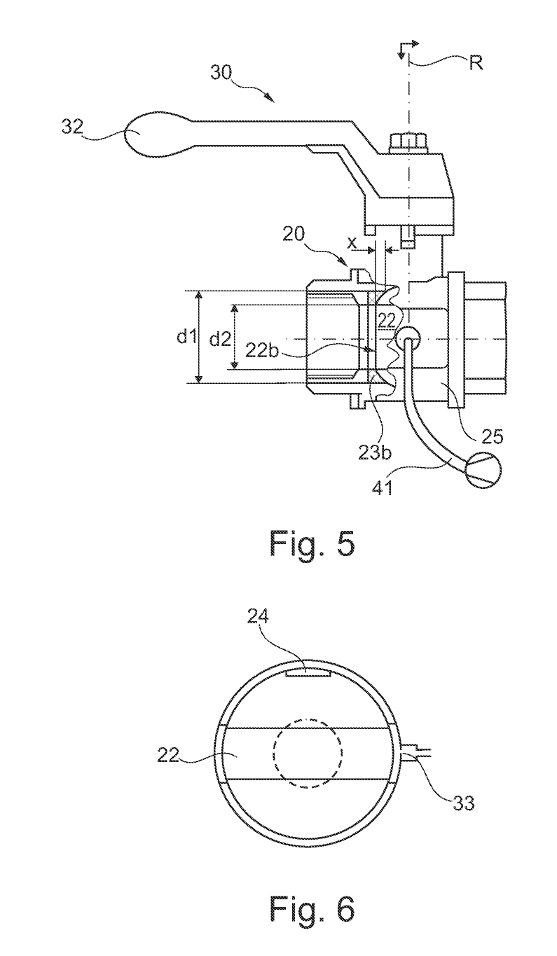

FIG. 5 shows an alternative pipe-closing apparatus of a second embodiment, in isolation, with compressed air fed into the passage via the valve housing; and

FIG. 6 shows an enlarged detail of the closing element of the pipe-closing apparatus according to FIG. 5.

In the following description of the preferred embodiment of the present invention, the same reference symbols denote same or comparable components.

FIG. 1 shows in a side view an ice cream machine with a pipe-closing apparatus in an open position, comprising a butterfly valve 20, arranged in a pipeline 10 and having a closing element 21 which is designed with two sealing portions 21a and 21b with respect to the pipeline 10, and an activation apparatus 30 for transferring the closing element 21 into an open or closed position and vice versa.

Discernibly, the closing element 21 is formed by a three-dimensional, rotationally symmetrical body. As represented, a bored-through sphere, in particular, has proved successful as a closing element 21, the through bore forming the passage 22. In the open position of the closing element 21, the inlet opening 22a as well as the outlet opening 22b of the through bore 22 are aligned with the pipeline 10.

The pipeline 10 connects, for instance, an upper tank 11 to a lower tank 12. For the specific case of a machine for producing ice cream, the pasteurization of the milk-based starting mixture is carried out in the upper tank 11, whereas the thickening can be carried out in the lower tank 12.

Whilst the supply from the upper tank 11 could already be closed off by means of a first sealing portion 21a, it is only once a second sealing portion 21b is provided that a pressure monitoring is enabled. At the same time, the second sealing portion 21b advantageously prevents liquids beaten upward out of the second tank 12 from forming potential germ pools.

In order that food mixtures such as ice cream, caramel, jam, candies, crème bavaroise, milk cream, confectioner's creams or other substances which thicken already with the heating (pasteurization) can flow without hindrance from the upper tank 11 into the lower tank 12, the diameter of the through bore 22 is preferably configured substantially equal to the inner diameter of the pipeline 10.

The transfer of the closing element 21 from the open position into the closed position is realized by means of an activation device 30, which is formed, for instance, by a pivot 31 which makes contact along the rotational axis R of the closing element 21. That end of the pivot 31 which is facing toward the closing element 21 is preferably designed such that it can engage in a receptacle 24 configured in the closing element 21 and can transmit a torque to the closing body 21.

At the opposite end of the pivot 31 facing away from the closing element 21, a manual operating element 32 or an automated actuator for transferring the rotationally symmetrical body into the open or closed position and vice versa can selectively be provided. Insofar as an automated actuator is used (not represented), this can be configured such that it is hydraulically, pneumatically and/or electromechanically operable.

FIG. 2 shows the ice cream machine from FIG. 1 with the pipe-closing apparatus in the closed position of the closing element 21.

The sealing seat of the butterfly valve 20, i.e. the two sealing portions 21a, 21b of the closing element 21, are formed by shell surfaces. of the spherically or rotationally symmetrical body, which bear against sealing bodies 23a, 23b of spherically layered—or, insofar as other rotationally symmetrical bodies are used as the closing element 21, rotationally layered—configuration.

It is only the sealing seat of the butterfly valve 20, which sealing seat is formed from a first 21a and second 21b sealing portion, which in the closed position allows the through bore 22 of the closing element 21 to be pressurized by a pneumatic circuit 40 for the intake of compressed air.

To this end, dry air of a compressor 42 is fed to the pneumatic circuit 40. Pressure measuring apparatuses are placed one behind the other on the feed pipe 41 in order to keep the system pressure constant and intervene in the event of falls in pressure. A high pressure monitor 43 and a low pressure monitor 44 keep the pressure within a predefined range of values, for example between an overpressure of 0.1 bar, measured relative to atmospheric pressure or air pressure, and an overpressure of 0.05 bar. In another embodiment (not represented), just one electronic monitor can be provided, which monitor is suitable for detecting upwardly and downwardly directed pressure changes so as to maintain, for example, a constant overpressure value of 0.02 bar.

An air reserve tank 45 placed in the, feed pipe 41 acts as a type of pulmonary ventricle in order to equalize pressure changes between the unloading and supply phases of the compressor 42.

A, for instance, magnetic position sensor 52, which is connected by means of an electric cable 51 to an electronic control unit 50, is placed adjacent to the pivot 31. Thus, an acoustic signal, for instance, can warn an operator when the closing element 21 of the butterfly valve 20 is in an open position, whereby an untimely, accidental filling of the upper tank 11 is avoided when the pipeline 10 is not closed.

The electronic control unit 50 processes the signals emanating from the monitors 43 and 44 and from the position sensor 52, whereupon the unit 50, via electric cables 51, can control the operation of the compressor 42 as well as, if need be, other peripheral equipment, for example a printer for registering the process or the buzzer of an alarm system.

FIG. 3 shows the pipe-closing apparatus from FIGS. 1 and 2 in isolation, with compressed air fed into the passage 22 via the pivot 31; FIG. 4 shows an enlarged detail of the closing element 21 of the pipe-closing apparatus according to FIG. 3.

The small diameter d2 of the sealing bodies 23a, 23b bearing in spherically or rotationally layered configuration against the shell surface of the spherically or rotationally symmetrical body here preferably always corresponds to the diameter of the inlet 22a or outlet opening 22b of the through bore 22 configured in the spherically symmetrical body 21.

By contrast, in the illustrative embodiment according to FIG. 3 or 4, the large diameter d1 of the sealing body 23a, 23b bearing in spherically or rotationally layered configuration against the shell surface of the spherically or rotationally symmetrical body 21 substantially corresponds to the maximum diameter of the spherical closing element 21.

Since, in this first embodiment of a valve 20, two sealing bodies 23a and 23b, which ultimately extensively cover the shell surface of the spherical body 21, are provided between the two sealing portions 21a and 21b and the pipeline 10, it is preferred that the compressed air is guided into the through bore 22 through preferably mutually corresponding openings 33 configured in the pivot 31 and in the top side of the spherical body. Due to the introduction of compressed air through the pivot 31, no change in or, as a consequence thereof, even damage to the sealing bodies 23a and 23b is produced, which precludes the danger of potential germ pools.

FIG. 5 shows an alternative pipe-closing apparatus of a second embodiment, in isolation, with compressed air fed into the passage 22 via the valve housing 25; FIG. 6 shows an enlarged detail of the closing element 21 of the pipe-closing apparatus according to FIG. 5.

The small diameter d2 of the sealing bodies 23a, 23b bearing in spherically or rotationally layered configuration against the shell surface of the spherically or rotationally symmetrical body 21 here preferably again corresponds to the diameter of the inlet 22a or outlet opening 22b of the through bore 22 configured in the spherically symmetrical body 21.

By contrast, in the illustrative embodiment according to FIG. 5 or 6, the large diameter dl of the sealing body 23a, 23b bearing in spherically or rotationally layered configuration against the shell surface of the spherically or rotationally symmetrical body 21 is now arranged already just a few millimeters x, for example between 1.5 and 5 millimeters, distant from the small diameter d2.

Since, in this second embodiment of a valve 20, sealing bodies 23a and 23b, which are respectively in the shape of a ring seal, i.e. ultimately partially cover the shell surface of the spherical body 21, are provided between the two sealing portions 21a and 21b and the pipeline 10, it is preferred that the compressed air is guided into the through bore 22 through an opening 33 configured in the valve housing 25. The inherent risk of germ pool formation is here likewise advantageously precluded.

The working principle of a machine for processing food mixtures shall be explained below by way of example with reference to an ice cream machine:

The operation of the pneumatic circuit 40 is realized in a fully automated manner by the electronic control center 50 on the basis of the signals detected by the position sensors 52 and the pressure sensors 43 and 44 or by the single electronic monitor.

When the magnetic sensor 52 actually detects that the closing element 21 of the butterfly valve 20 is in a closed position, the compressor 42 forces pressurized air through the feed pipe 41 and the openings 33, whereupon the passage 22 in the closing element 21 of the valve 20 is pressurized.

Once the maximum preset system pressure is reached, which is equal, for example, to an overpressure of 0.1, bar, as detected by the high pressure monitor 43, the compressor 42 stops.

A constant maximum system pressure must be ensured when the closing element 21 of the valve 20 is in a closed position. If, despite the lastingly improved sealing effect due to sealing portions 21a and 21b which are effective over a wide area, a loss should nevertheless arise in the pneumatic circuit 40, the fall in pressure is recognized by the low pressure monitor 44 and a fault in the machine is indicated for the purpose of replacement of the sealing seat(s).

At the end of the pasteurizing process of the food mixture in the upper tank 11, which is recognized, for example, by means of a temperature control apparatus, the operator, for example, manually opens the butterfly valve 20 by actuation of an operating element 32, thereby effecting the opening of the pressurized circuit 40.

Alternatively, the control center 50 can itself operate the automatic opening and closing of the butterfly valve 20, for instance by means of an electric motor not represented).

In any event, the compressor 42 only pressurizes the pneumatic circuit 40 when the position sensor 52 indicates that the butterfly valve 20 has been brought back into a closed position.

With the pneumatic circuit 40 or the electronic control unit 50, the precisely fitting sealing seat of the butterfly valve 20 is thus in the closed position continuously monitorable and at the same time ensures a lawful food preparation.

The inventive pipe-closing apparatus of a machine which is configured to be suitable for processing food mixtures is equally suitable for use in a machine for producing a milk-containing ice cream as for processing or preparing, for example, caramel, jam, candies, crème bavaroise, milk cream or so-called confectioner's creams.

### REFERENCE SYMBOL LIST

1 machine for processing food mixtures, in particular an ice cream machine

10 pipeline; pipe

11 upper tank

12 lower tank

20 butterfly valve

21 closing element; three-dimensional, rotationally symmetrical body

21a first sealing portion

21b second sealing portion

22 passage, through bore

22a inlet opening of the passage 22

22b outlet opening of the passage 22

23a first sealing body of the butterfly valve 20

23b second sealing body of the butterfly valve 20

24 receptacle

25 valve housing

R rotational axis of the closing element 21

d1 large diameter of the sealing bodies 23a and 23b bearing in spherically or rotationally layered configuration against the shell surface of the spherically or rotationally symmetrical body of the closing element 21.

d2 small diameter of the sealing bodies 23a and 23b bearing in spherically or rotationally layered configuration against the shell surface of the spherically or rotationally symmetrical body of the closing element 21.

30 activation apparatus

31 pivot

32 manual operating element

33 openings in the pivot 31, closing element 21 and/or valve housing 35 for the supply of compressed air into the passage 22

40 pneumatic circuit

41 feed pipe for compressed air

42 compressor

43 high pressure monitor

44 low pressure monitor

45 air reserve tank

50 control unit

51 electric cables

52 magnetic position sensor

1-15. (canceled)

16. A pipe-closing apparatus for a machine suitable for processing food mixtures, including for producing a milk-based ice cream, wherein at least one of raw milk or other unpasteurized products can wholly or partially be used as a base product, the pipe-closing apparatus comprising:
a butterfly valve disposed in a pipeline and having a closing element configured with two sealing portions with respect to the pipeline, said closing element containing a symmetrical body having a passage with an inlet opening and an outlet opening formed therein;
an activation apparatus for transferring said closing element from an open position into a closed position and vice versa, in the open position of said closing element, at least said inlet and outlet openings of said passage are aligned with the pipeline; and
a pneumatic circuit, in the closed position of said closing element, said passage is subjected to a pressure by said pneumatic circuit for an intake of compressed air.

17. The pipe-closing apparatus according to claim 16, wherein said symmetrical body is a hollow body, said symmetrical body having a cavity forming said passage.

18. The pipe-closing apparatus according to claim 16, wherein said symmetrical body is a solid body having a through bore formed therein and forming said passage.

19. The pipe-closing apparatus according to claim 16, wherein a diameter of said inlet opening and a diameter of said outlet opening of said passage are substantially equal to an inner diameter of the pipeline.

20. The pipe-closing apparatus according to claim 16, wherein said activation apparatus has a pivot which makes contact along a rotational axis of said closing element.

21. The pipe-closing apparatus according to claim 20, wherein said closing element has a receptacle formed therein, and an end of said pivot which is facing toward said closing element engages in said receptacle.

22. The pipe-closing apparatus according to claim 20, wherein said activation apparatus has an operating element selected from the group consisting of a manual operating element and an automated operating element, and at an end of said pivot facing away from said closing element is disposed said operating element for transferring said closing element into the open position or the closed position and vice versa.

23. The pipe-closing apparatus according to claim 16, wherein said symmetrical body has a form of a body selected from the group consisting of a spherically symmetrical body, a double-cone body and an ellipsoid.

24. The pipe-closing apparatus according to claim 16, wherein said two sealing portions of said closing body are formed by shell surfaces of said symmetrical body selected from the group consisting of a spherically symmetrical body and a rotationally symmetrical body.

25. The pipe-closing apparatus according to claim 24, wherein said butterfly valve has sealing bodies formed in a layered configuration selected from the group consisting of a spherically layered configuration and a rotationally layered configuration, said two sealing portions of said closing body bear against said sealing bodies.

26. The pipe-closing apparatus according to claim 25, wherein a small diameter of said sealing body bearing in said layered configuration against a shell surface of said symmetrical body of said closing element corresponds to a diameter of said inlet opening or said outlet opening of said passage configured in said symmetrical body of said closing element.

27. The pipe-closing apparatus according to claim 26, wherein a large diameter of said sealing body bearing in said layered configuration against said shell surface of said symmetrical body of said closing element is disposed to end already just a few millimeters.

28. The pipe-closing apparatus according to claim 16, wherein said butterfly valve has a valve housing with an opening formed therein, the compressed air being guided into said passage through said opening in said valve housing.

29. The pipe-closing apparatus according to claim 16, wherein said symmetrical body forming said closing element is produced from a food-suitable material.

30. The pipe-closing apparatus according to claim 25, wherein said sealing bodies are configured to be suited to a working pressure and to a working temperature of the machine and are produced from polyethylene (PE)-containing plastics or from a ceramic.

31. The pipe-closing apparatus according to claim 22, wherein said automated operating element is selected from the group consisting of a hydraulically operable actuator, a pneumatically operable actuator and an electrically operable actuator.

32. The pipe-closing apparatus according to claim 20, wherein:
said pivot has mutually corresponding openings formed therein; and
said closing element having a top side with a top opening formed therein, the compressed air being guided into said passage through said openings configured in said pivot and through said top opening of said closing element.

33. The pipe-closing apparatus according to claim 29, wherein said food-suitable material is selected from the group consisting of metal, aluminum, a polyethylene (PE)-containing plastic and a ceramic.

34. The pipe-closing apparatus according to claim 26, wherein a large diameter of said sealing body bearing in said layered configuration against said shell surface of said symmetrical body of said closing element is disposed to end between 1.5 and 5 millimeters, distant from the small diameter.

35. The pipe-closing apparatus according to claim 27, wherein a large diameter of said sealing body bearing in said layered configuration against said shell surface of said symmetrical body of said closing element substantially corresponds with a maximum spherical diameter.

36. The pipe-closing apparatus according to claim 27, wherein a large diameter of said sealing body bearing in said layered configuration against said shell surface of said symmetrical body of said closing element substantially corresponds with a maximum rotational body diameter.

37. A machine for processing food mixtures, the machine comprising:
a first tank;
a second tank; and
a pipe-closing assembly connecting said first tank to said second tank, said pipe-closing assembly containing:
a pipeline connected between said first tank and said second tank;
a butterfly valve disposed in said pipeline and having a dosing element configured with two sealing portions with respect to said pipeline, said closing element containing a symmetrical body having a passage with an inlet opening and an outlet opening formed therein;
an activation apparatus for transferring said closing element from an open position into a closed position and vice versa, in the open position of said closing element, at least said inlet and outlet openings of said passage are aligned with said pipeline; and
a pneumatic circuit, in the dosed position of said closing element, said passage is subjected to a pressure by said pneumatic circuit for an intake of compressed air.

38. An ice cream machine, comprising:
a first tank;
a second tank; and
a pipe-closing assembly connecting said first tank to said second tank, said pipe-closing assembly containing:
a pipeline connected between said first tank and said second tank;
a butterfly valve disposed in said pipeline and having a closing element configured with two sealing portions with respect to said pipeline, said closing element containing a symmetrical body having a passage with an inlet opening and an outlet opening formed therein;
an activation apparatus for transferring said closing element from an open position into a dosed position and vice versa, in the open position of said closing element, at least said inlet and outlet openings of said passage are aligned with said pipeline; and
a pneumatic circuit, in the closed position of said closing element, said passage is subjected to a pressure by said pneumatic circuit for an intake of compressed air.
